(19) United States
(12) Patent Application Publication
(10) Pub. No.: US 2006/0026856 A1
(43) Pub. Date: Feb. 9, 2006

(54) Method for scoring antlers

(76) Inventor: Rodney D. Scott, Excelsior Springs, MO (US)

Correspondence Address: CHASE LAW FIRM L.C, 4400 COLLEGE BOULEVARD, SUITE 130, OVERLAND PARK, KS, 66211, US

(21) Appl. No.: 10/911,001

(22) Filed: Aug. 4, 2004

(51) Int. Cl. G01B 3/10

(52) U.S. Cl. 33/759

(57) ABSTRACT

An elongated, flexible, graduated rule having an adhesive back is applied in appropriate lengths to measure the main beam and other features along the surface of an antler that are considered in a scoring system. The measurement from each of the lengths is read and recorded.

This invention relates to a method of measuring the antlers of game animals in the field in order to obtain an accurate estimate of the final score, which is determined under standards established by hunting clubs and societies.

### BACKGROUND OF THE INVENTION

The Pope & Young Club, Boone and Crockett Club, Longhunters Society and Safari Club International all use a system for scoring the antlers of game animals. The system is used as a means for determining antler quality for management purposes, record books and awards. Pope & Young publishes a score sheet containing the official scoring system for bow hunting North American big game. Likewise, Boone and Crockett publishes an essentially identical score sheet for scoring North American big game taken with firearms.

Antlers are scored by an official scorer of the club. Official measurements are not taken until after a rack has air dried for at least sixty days after the date of the kill. However, immediately after the kill a hunter with a possible big game trophy is eager to learn if the rack may qualify for entry into the club record book, but it is difficult to rough-score a rack in the field to give the hunter some idea at the time of the kill as to whether the animal is of trophy category by club standards.

The minimum score for entry into the Pope & Young record book for a typical rack is 125 points. For a non-typical rack, the minimum score is 150 points. The final score is determined by summing a number of measurements as set forth on Pope & Young and Boone and Crockett score sheets. For example, the length of each point of the rack is measured as well as circumferences along a main beam between points, thus a trophy rack may be the summation of a number of precise measurements.

### BRIEF DESCRIPTION OF THE INVENTION

In an embodiment of the present invention the aforementioned problem of rough scoring a rack in the field is addressed by providing a method of measuring an antler in the field. The hunter is provided with an elongated, flexible, graduated rule having an adhesive back. A length of the rule is applied to a main beam of an antler along the length of the beam from burr to tip. Additional lengths of the rule are applied at other locations along the main beam as required by Pope & Young and Boone and Crockett standards. These measurements are repeated on the other main beam of the antler, and all of the measurements read from the lengths are recorded. The measurements taken may be entered on a standard Pope & Young or Boone and Crockett score sheet and combined with overall measurements which are easily obtained (such as tip-to-tip spread, inside spread of the main beams, and greatest beam spread) to provide totals for estimating the final score.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a side view of the right half of an illustrative rack of a whitetail deer.

FIG. 2 is a front view of the complete rack.

FIG. 3 is a detail showing a short length of a measuring tape.

FIG. 4 is an illustration showing a roll of the measuring tape.

FIG. 5a is a view similar to FIG. 1 showing the application of a first length of the tape to a main beam of the antler.

FIG. 5b is a view similar to FIG. 5a but showing the addition of measuring tape to three locations to measure circumference.

FIG. 5c is a view similar to FIG. 5b but showing the further application of measuring tape along the tines that present the points of the antler.

FIG. 6 is a detail of one of the circumferential measurements.

### DETAILED DESCRIPTION

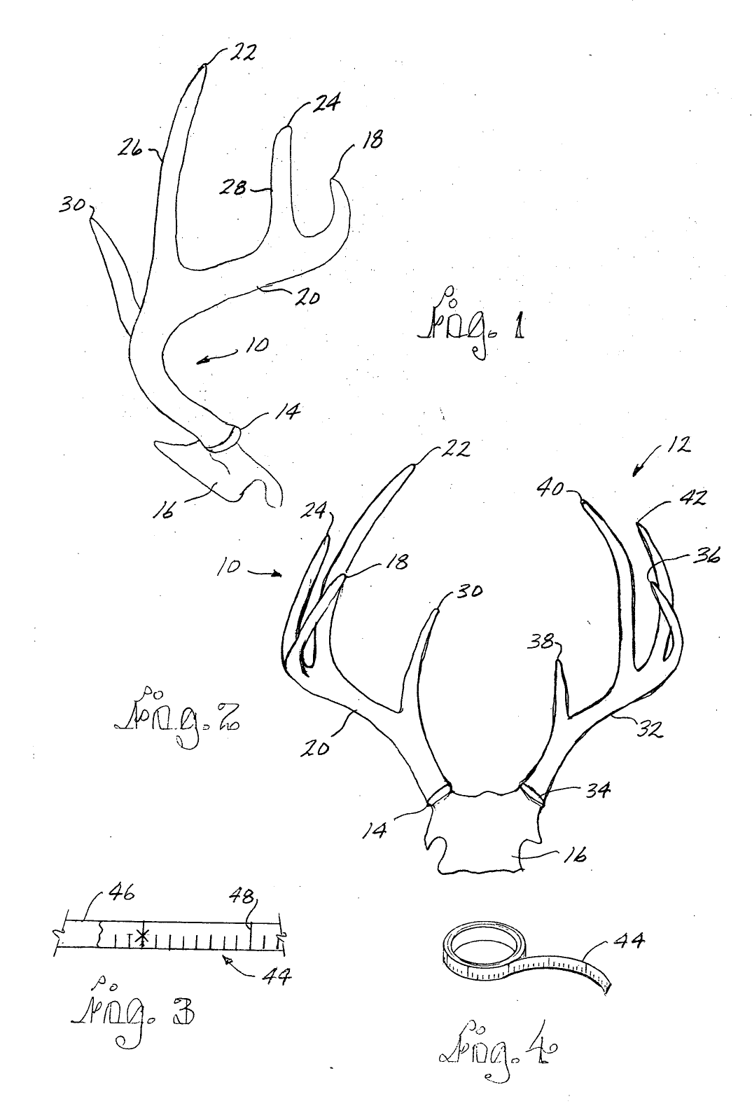

Typical antlers of a whitetail deer are shown in full in FIG. 2 in a frontal view, and include a right antler 10 and a left antler 12. The right antler 10 extends from burr 14 at skull 16 to the tip 18 of antler 10, as best seen in the side view of FIG. 1. Accordingly, a main beam 20 is presented extending from burr 14 to tip 18.

The main beam 20 of antler 10 has a pair of spaced points 22 and 24 presented by tines 26 and 28 respectively, that project upwardly from main beam 20. A first point 30 projects upwardly from main beam 20 at a branch closest to the burr 14, thus points 22 and 24 are referred to as the second point and the third point, respectively.

Similarly, the left antler 12 has a main beam 32 extending upwardly from burr 34 and terminating at tip 36. The right antler 12 has a first point 38, a second point 40 and a third point 42.

The antlers are measured in the field utilizing a flexible, graduated rule 44, a roll thereof being illustrated in FIG. 4. The rule 44 illustrated comprises a measuring tape provided with an adhesive back to which a removable backing strip 46 is adhered prior to cutting a length of the tape 44 from the roll and applying it in a manner to be described hereinbelow. Each inch is marked as seen at 48 and an “X” is printed on the tape at 10-inch increments as illustrated in FIG. 3. Each inch is graduated in eighths of an inch pursuant to the club requirements that measurements be made to the nearest one-eighth of an inch.

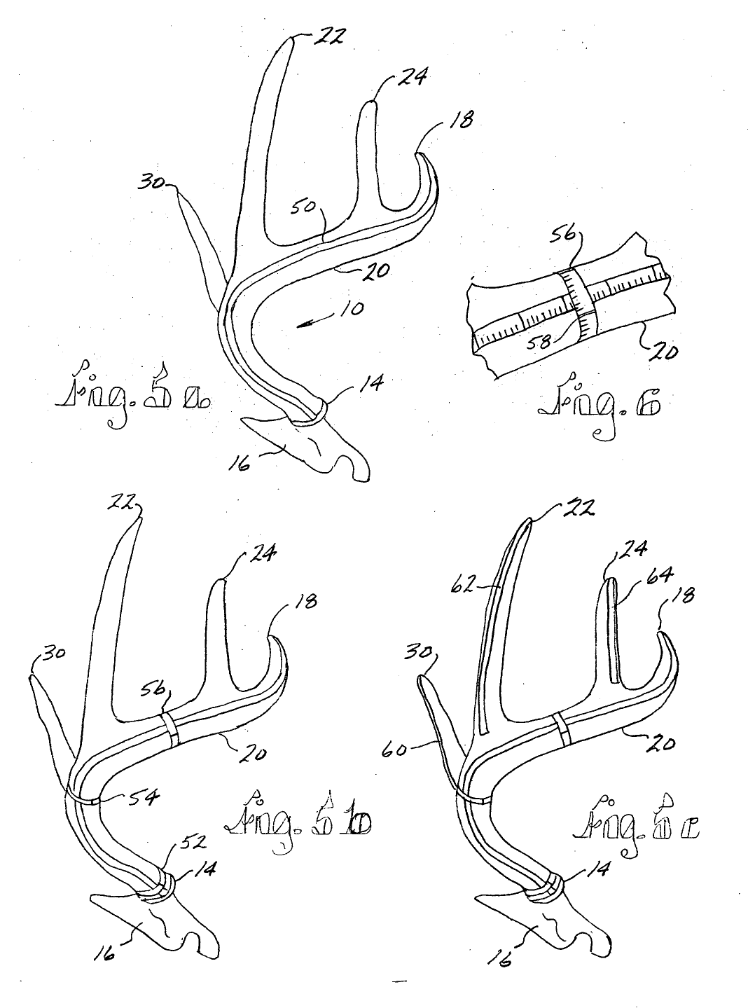

FIGS. 5a, 5b, 5c and 6 show the manner in which lengths of tape 44 are applied to antler 10, it being appreciated that similar measurements are made on antler 12. First, as shown in FIG. 5a, a length 50 of tape is applied to the main beam 20 along a length thereof from the burr 14 to the tip 18. The backing strip 46 is removed from the tape as it is applied in accordance with Pope & Young and Boone and Crockett requirements, i.e., from the center of the lowest outside edge of burr 14 over the outer side to the most distant point 18 of beam 20. (It will be appreciated that in FIGS. 5a, 5b and 5c that the antler 10 is rotated to the front from horizontal to better show the positions of the tapes.) Utilizing a plastic tape 44, it may be easily cut with a small scissors or pocket knife to fit exactly as shown. From the graduations on the tape, the length measurement is read and recorded on a score sheet, such as provided by Pope & Young or Boone and Crockett.

FIG. 5b illustrates the application of three lengths 52, 54 and 56 of tape to three locations as shown. Length 52 is applied to the main beam 20 at the location between the burr 14 and the first point 30 where the circumference of the main beam is the smallest, which may be seen as adjacent the burr 14. The length 54 is applied at the location between point 30 and point 22 where the circumference of the main beam is the smallest. Similarly, the length 56 is applied to the main beam 20 where the circumference between points 22 and 24 is the smallest. If there were additional points, the minimum circumferences would likewise be measured. Readings from these measurements are also recorded on the score sheet.

FIG. 6 is a detail view showing the application of tape length 56. The length of tape is cut such that the opposed ends abut at 58 thereby providing an accurate measurement of the circumference.

FIG. 5c shows the use of tape 44 to apply lengths 60, 62 and 64 thereof to the tines that present the three points 30, 22 and 24. Each of the points illustrated is a normal point projecting from the top of the main beam 20. Each is measured by applying a length of tape along the tine from the top edge of the main beam 20, over the outer curve of the tine to the tip. These measurements are also read and recorded on the score sheet.

With all measurements recorded, the hunter can total the recorded data and have an accurate estimate of the score. Using the graduated, self-adhesive tape as described above, the difficult measurements along the contours of the beam and points are readily made in the field. Although the use of a self-adhesive tape is illustrated herein, it should be understood that other self-adhesive rulers could be utilized, such as a plastic filament with a bead of adhesive on one side, the other side bearing marks corresponding to the one-eighth inch increments.

It is to be understood that while certain forms of this invention have been illustrated and described, it is not limited thereto, except insofar as such limitations are included in the following claims and allowable equivalents thereof.

Having thus described the invention, what is claimed as new and desired to be secured by Letters Patent is as follows:

1. A method of measuring an antler comprising the steps of:
(a) providing an elongated, flexible, graduated rule having an adhesive back,
(b) applying a first length of said rule to a main beam of an antler along the length of the beam from burr to tip,
(c) applying a second length of said rule to said main beam therearound at a location between the burr and a first point, and where at said location the circumference of the main beam is the smallest,
(d) applying an additional length of said rule to said main beam at each additional location between successive points where the circumference of the main beam is the smallest,
(e) reading the measurement from each of the lengths, and
(f) recording the measurements read.

2. The method as claimed in claim 1, further comprising the step of repeating said steps (b) through (e) on a second main beam of said antler, and recording the measurements read.

3. The method as claimed in claim 1, further comprising the step of applying another length of said rule to said first point along the length thereof from said main beam to a terminal end of said first point, reading the measurement therefrom and recording the measurement read.

4. The method as claimed in claim 3, further comprising applying a further length of said rule to each additional point along the length thereof from said main beam to a terminal end of the respective point, reading each additional measurement and recording each such measurement read.

5. The method as claimed in claim 1, wherein said rule comprises a measuring tape provided with said adhesive back.

6. The method as claimed in claim 5, wherein said tape has a backing strip on said adhesive back removable therefrom for applying the tape to the antler.

7. A method of measuring an antler comprising the steps of:
(a) providing an elongated, flexible, graduated rule having an adhesive back,
(b) applying a first length of said rule to a main beam of an antler along the length of the beam from burr to tip,
(c) applying a second length of said rule to said main beam therearound at a location between the burr and a first point, and where at said location the circumference of the main beam is the smallest,
(d) applying another length of said rule to said first point along the length thereof from said main beam to a terminal end of said first point,
(e) reading the measurement from each of the lengths, and
(f) recording the measurements read.

8. The method as claimed in claim 7, wherein said rule comprises a measuring tape provided with said adhesive back.

9. The method as claimed in claim 8, wherein said tape has a backing strip on said adhesive back removable therefrom for applying the tape to the antler.
